(19) United States
(12) Patent Application Publication
(10) Pub. No.: US 2004/0085536 A1
(43) Pub. Date: May 6, 2004

(54) Tomography system and method using nonlinear reconstruction of scattered radiation

(76) Inventors: John Carl Schotland, Wynnewood, PA (US); Vadim Arkadievich Markel, Richmond Heights, MO (US); Joseph Andrew O'Sullivan, St. Louis, MO (US)

Correspondence Address: John T. Peoples, 14 Blue Jay Court, Warren, NJ, 07059, US

(21) Appl. No.: 10/286,019

(22) Filed: Nov. 1, 2002

(51) Int. Cl. G01N 21/00

(52) U.S. Cl. 356/340

(57) ABSTRACT

A methodology and concomitant system for the nonlinear reconstruction of an object from measurements of the transmitted intensity of scattered radiation effected by irradiating the object with a source of radiation. The transmitted intensity is related to either the absorption coefficient or diffusion coefficient, or both, of the object by an integral operator. The image is directly reconstructed by executing a prescribed mathematical algorithm, as determined with reference to the integral operator, on the transmitted intensity of the scattered radiation. The mathematical algorithm includes computing a functional series expansion for the coefficient(s) in powers of the transmitted intensity.

### BACKGROUND OF THE DISCLOSURE

1.) Field of the Invention

This invention relates to tomography and, more particularly, to method and concomitant system wherein an image of an object is directly reconstructed from measurements of scattered radiation using a nonlinear reconstruction technique.

2.) Description of the Background Art

There has been considerable interest in the inverse scattering problem (ISP) for diffuse light. The basic physical problem consists of reconstructing the spatial distribution of the optical absorption and diffusion coefficients inside a highly-scattering medium from intensity measurements on the boundary of the medium.

The equations describing scattering of diffuse light from fluctuations in the absorption and diffusion coefficients oz and D are, in general, nonlinear. Thus numerical methods for solving the nonlinear inverse problem have been widely studied and are typically based upon Newton's method. A limitation of this approach is its computational complexity which arises from the fact that the forward problem must be solved at each iteration of the algorithm.

Approaches to the inverse problem based upon linearization of the forward problem have also been explored. In this method, the integral equations of diffuse light propagation are expanded and linearized in α and D. These equations can then be solved with the use of analytic inversion formulas. The use of inversion formulas is especially attractive due to computational efficiency. Representative of this technique are the disclosures of U.S. Pat. No. 5,905,261, the Background section of which is incorporated herein by reference.

The art is devoid of a methodology, and concomitant system, wherein the nonlinear equations describing diffusion and absorption of an image are directly solved to thereby effect direct, but generalized, reconstruction of the image. That is, in the past, only explicit inversion formulas for the case of linearized ISP have been obtained; explicit inversion formulas for nonlinear ISP case have not been devised.

### SUMMARY OF THE INVENTION

These and other shortcomings are obviated in accordance with the present invention via a technique whereby an object is irradiated with a source of radiation and then waves diffusively scattered from the object are processed with a prescribed nonlinear mathematical algorithm to reconstruct the tomographic image.

In accordance with one broad method aspect of the present invention, the method for generating a tomographic image of an object includes: (i) irradiating the object with a source of radiation; (ii) measuring a transmitted intensity due to diffusively scattered radiation wherein said transmitted intensity is related to at least one coefficient characterizing the image by a nonlinear integral operator; and (iii) directly reconstructing the image by executing a prescribed mathematical algorithm, determined with reference to said integral operator, on said transmitted intensity.

In accordance with another broad method aspect of the present invention, the method for generating a tomographic image of an object ineludes: (i) irradiating the object with a source of radiation; (ii) measuring a transmitted intensity due to diffusively scattered radiation wherein said transmitted intensity is related to at least one coefficient characterizing the image by a nonlinear integral operator; and (iii) directly reconstructing the image by executing a prescribed mathematical algorithm, determined with reference to said integral operator, on said transmitted intensity, said algorithm further relating said coefficient to said transmitted intensity by another nonlinear integral operator.

In accordance with yet another broad method aspect of the present invention, the method for generating a tomographic image of an object includes: (i) irradiating the object with a source of radiation, (ii) measuring a transmitted intensity due to diffusively scattered radiation wherein said transmitted intensity is related to at least one coefficient characterizing the image by a nonlinear integral operator, and (iii) directly reconstructing the image by executing a prescribed mathematical algorithm, determined with reference to said integral operator, on said transmitted intensity, said mathematical algorithm expressed as a functional series expansion for said coefficient in powers of said transmitted intensity.

Broad system aspects of the present invention are commensurate with the broad method aspects.

The features of the this approach are at least two-fold: (i) the approach provides a formally exact solution to the ISP in diffusion tomography. The approach may be viewed as a nonlinear inversion formula whose first term coincides with the pseudoinverse solution to the linearized ISP. The higher order terms represent systematically improvable nonlinear corrections which, in principle, can be computed to arbitrarily high order. Thus, it is only necessary to solve the linear ISP in order to formally solve the nonlinear ISP; and (ii) the approach to the ISP differs from Newton-type iterative methods. This follows from the fact that such prior methods require the conventional forward problem to be solved for each iteration.

### BRIEF DESCRIPTION OF THE DRAWING

FIG. 1 is a high-level block diagram of a system for directly reconstructing the tomographic image of the scatterer

FIGS. 2A-2D depict direct reconstruction results for an exemplary scatterer using different ratios of parameters;

FIGS. 3A-3D depict direct reconstruction results for an exemplary scatterer using the same parameters different from FIGS. 2A-2D that exemplify increased resolution with higher-order terms;

FIG. 4 depicts the convergence of the higher order corrections to the true profile;

FIG. 5A is a high-level flow diagram of the methodology for directly reconstructing the tomographic image of the scatterer; and

FIG. 5B is another high-level flow diagram of the methodology for directly reconstructing the tomographic image of the scatterer commensurate with the functional series technique.

### BACKGROUND OF THE DISCLOSURE

1. System

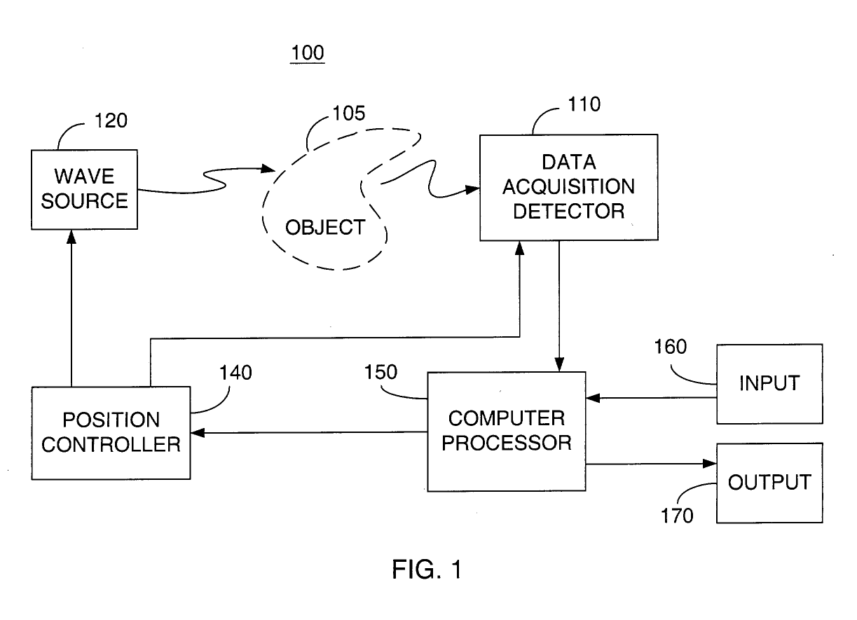

As depicted in high-level block diagram form in FIG. 1, system 100 is a tomography system for generating an image of an scatterer/object using measurements of scattered waves emanating from an object in response to waves illuminating the object. In particular, object 105 is shown as being under investigation. System 100 is composed of: source 120 for probing the object 105; data acquisition detector 130 for detecting the scattering data corresponding to the scattered waves from object 105 at one or more locations proximate to object 105; position controller 140 for controlling the locations of detectors 130 and sources 120; and computer processor 150, having associated input device 160 (e.g., a keyboard) and output device 170 (e.g., a graphical display terminal). Computer processor 150 has as its inputs positional information from controller 140 and the measured scattering data from detector 130.

Computer 150 stores a computer program which implements the direct reconstruction algorithm; in particular, the stored program processes the measured scattering data to produce the image of the object under study using a prescribed mathematical algorithm. The algorithm is, generally, based upon a functional expansion of the absorption and diffusion coefficients of the object in terms of tensor products of the measured scattering data. The algorithm will be described in detail below.

2. Overview of the Underlying Mathematical Formalism

We begin by setting forth the relevant mathematical formalism which serves as a backdrop to the point of departure in accordance with the present invention. We assume that the energy density u(r, t) of diffuse light in an inhomogeneous medium obeys the diffusion equation

$$\frac{\partial u ( r , t )}{\partial t} = ∇ \cdot [ D ( r ) ∇ u ( r , t ) ] - α ( r ) u ( r , t ) + S ( r , t ) , \qquad ( 1 )$$

where α(r) and D(r) are the position-dependent absorption and diffusion coefficients, and S(r, t) is the power density of the source. We further assume that the source is harmonically modulated with angular frequency ω. In addition to (1), the energy density must satisfy boundary conditions on the surface of the medium (or at infinity in the case of free boundaries) of the general form

u+l\hat{n}·∇u=0, (2)

where l is the so-called extrapolation length and \hat{n} is an outward pointing normal. Note that when l=0 we obtain purely absorbing boundaries and when l→∞ purely reflecting boundaries.

In general, the so-called Green's function may be directly related to the intensity measured by a point detector when the medium is illuminated by a point source. The Green's function G(r₁, r₂) for the frequency-domain diffusion equation obeys the integral equation

(r′,r₂)=G₀(r₁,r₂)−∫d³rG₀(r₁,r)V(r)G(r,r₂), (3)

where G₀ is the Green's function for a homogeneous medium with absorption α₀ and diffusion constant D₀. We have also introduced the notation

V(r)≡δα(r)−∇·δD(r)∇, (4)

where δα(r)=α(r)−α₀ and δD(r)=D(r)−D₀. The unperturbed Green's function G₀(r, r′) obeys the boundary condition (2) and satisfies

$$( {∇}^{2} - {k}^{2} ) {G}_{0} ( r , {r}^{′} ) = - \frac{1}{{D}_{0}} δ ( r - {r}^{′} ) , \qquad ( 5 )$$

where the diffuse wave number k is given by

$${k}^{2} = \frac{{α}_{0} - ⅈ ω}{{D}_{0}} . \qquad ( 6 )$$

It can be shown that the change in the intensity of transmitted light (at the modulation frequency ω) due to spatial fluctuations in α(r) and D(r) is given by the integral equation

Φ(r₁,r₂)=β∫G₀(r₁,r)V(r)G(r,r₂)d³r. (7)

Here the data function Φ(r₁, r₂) is proportional to the change in intensity relative to a reference medium with absorption α₀ and diffusion constant D₀, r₁ and r₂ denote the coordinates of the source and detector, and

$$β = \{ \begin{matrix}1 & for free boundaries \\ {( 1 + {l}^{*} / l )}^{2} & for boundary conditions expressed by ( 2 )\end{matrix} \qquad ( 8 )$$

with l*=3D₀/c.

The forward problem in diffusion tomography is defined as the problem of computing the data function Φ from the scattering potential η=(δα, δD). More precisely, the integral equation (7) may be regarded as defining a nonlinear operator K from the Hilbert space of scattering potentials H₁ into the Hilbert space of scattering data H₂. The fact that K is nonlinear may be understood by examining the perturbation expansion for Φ in powers of V. Using the series expansion for the Green's function G, which can be obtained by iterating the integral equation (3), and the definition of the data function (7) we obtain the required expansion:

Φ(r₁,r₂)=β∫d³rG₀(r₁,r)V(r)G₀(r,r₂)+β∫d³rd³r′G₀(r₁,r)V(r)G₀(r,r′)V(r′)G₀(r′,r₂)+ (9)

If only the first term in the series is retained we refer to this as the weak-scattering approximation.

The inverse problem in diffusion tomography is defined as recovering η from measurements of Φ. The standard numerical approach to this nonlinear problem is to employ a functional Newton's method. This results in an iterative algorithm of the form

ηₙ₊₁=ηₙ+Mₙ⁺(Φ−K{ηₙ}), n=1,2, . . . , (10)

where Mₙ⁺denotes the pseudoinverse of the functional derivative

$${M}_{n} = \frac{δ K}{δ η} {\vert}_{η = {η}_{n}} . \qquad ( 11 )$$

In accordance with the present inventive subject matter, we consider an alternative to the use of Newton's method. In particular, we construct a formally exact analytic solution to the nonlinear ISP. This solution, which we refer to as the inverse scattering series, has the form of a functional series expansion for 7 in powers of the data function 4). The first term in the expansion corresponds to the pseudoinverse solution to the linearized inverse problem. The higher order terms may be interpreted as nonlinear corrections to the singular value decomposition (SVD) inversion formulas of the linearized inverse problem.

The remainder of this description is organized as follows. In Section 2 we derive the inverse scattering series for diffusion tomography in its most general form, independent of geometry and the type of boundary conditions.

In Section 3 we consider the inverse problem in the biplanar geometry.

Section 4 details exemplary numerical results for the nonlinear reconstruction of a spherical inhomogeneity in the biplanar geometry.

Section 5 discusses a flow diagram of the process in accordance with the present invention.

Section 6 presents mathematical properties of the inverse scattering series and the derivation of the data function for a spherical inhomogeneity in the biplanar geometry with free boundaries.

2. INVERSE PROBLEM—Inverse Scattering Series

In this section we present the construction of the inverse scattering series for diffusion tomography.

The scattering series (9) can be rewritten in the form

Φ(r′,r₂)=∫d³rK₁ⁱ(r₁,r₂,r)ηᵢ(r)+∫d³rd³r′K₂^{ij}(r₁,r₂,r,r′)ηᵢ(r)ηⱼ(r′)+. . . , (12)

where

$$η ( r ) = ( \begin{matrix}{η}_{1} ( r ) \\ {η}_{2} ( r )\end{matrix} ) = ( \begin{matrix}δ α ( r ) \\ δ D ( r )\end{matrix} ) , \qquad ( 13 )$$

the action of the operator V has been taken into account and summation over repeated indices is implied with i, j=1, 2. The components of the operators K₁ and K₂ are given by

K₁¹(r₁,r₂;r)=βG₀(r₁,r)G₀(r,r₂) (14)

K₁²(r₁,r₂;r)=β∇ᵣG₀(r₁,r)·∇ᵣG₀(r,r₂), (15)

K₂¹¹(r₁,r₂;r,r′)=−βG₀(r′,r)G₀(r,r′)G₀(r′,r₂), (16)

K₂¹²(r₁,r₂;r,r′)=−βG₀(r′,r)∇_{r′}G₀(r,r′)·∇_{r′}G₀(r′,r₂), (17)

K₂²¹(r₁,r₂;r,r′)=−β∇ᵣG₀(r₁,r)·∇ᵣG₀(r,r′)G₀(r′,r₂), (18)

K₂²²(r₁,r₂;r,r′)=−β∇ᵣG₀(r₁,r)·∇ᵣ{∇_{r′}G₀(r,r′)·∇_{r′}G₀(r′,r₂)} (19)

The components of Kₙ are given by

$$\begin{matrix}{K}^{{i}_{1 n} … {i}_{n}} ( {r}_{1} , {r}_{2} ; {R}_{1} , … , {R}_{n} ) = {( - 1 )}^{n} {\sum }_{{α}_{1} , … , {α}_{n}}^{} \frac{{\partial }^{{i}_{1} - 1} {G}_{0} ( {r}_{1} , {R}_{1} )}{\partial {R}_{1 {α}_{1}}^{{i}_{1} - 1}} \frac{{\partial }^{{i}_{1} {i}_{2} - 2} {G}_{0} ( {R}_{1} , {R}_{2} )}{\partial {R}_{1 {α}_{1}}^{{i}_{1} - 1} \partial {R}_{2 {α}_{2}}^{{i}_{2} - 1}} \times ⋯ \\ \times \frac{{\partial }^{{i}_{n - 1} + {i}_{n} - 2} {G}_{0} ( {R}_{n - 1} , {R}_{n} )}{\partial {R}_{n - 1 , {α}_{n - 1}}^{{i}_{n - 1} - 1} \partial {R}_{n {α}_{n}}^{{i}_{n} - 1}} \frac{{\partial }^{{i}_{n} - 1} {G}_{0} ( {R}_{n} , {r}_{2} )}{\partial {R}_{n {α}_{n}}^{{i}_{n} - 1}} ,\end{matrix} \qquad ( 20 )$$

where α₁, . . . , αₙ label Cartesian components of the vectors R₁, . . . , Rₙ and no summation should be performed over indexes which are not explicitly present in the sum (i.e., for iₖ=1).

Observe that (12) is a functional power series expansion each term of which is multilinear in η. Thus we can expand Φ in tensor powers of

Φ=K₁η+K₂η [symbol] η+. . . , (21)

Here K₁ is a linear operator which maps the Hilbert space H₁ into the Hilbert space H₂ and K₂ may be interpreted as a tensor operator which maps H₁ [symbol] H₁ into H₂.

If the spatial fluctuations in α and D are sufficiently small, the series (21) may be truncated after its first term. This results in an effective linearization of the forward scattering problem with Φ=K₁η. The corresponding linear ISP has the solution η=K₁⁺Φ, where K₁⁺denotes the pseudoinverse of K₁. To construct the solution to the nonlinear ISP we act on (21) with the pseudoinverse operator K₁⁺and use the identity K₁⁺K₁=I_{H1}. We thus obtain

η=K₁⁺Φ−K₁⁺K₂η [symbol] η+. . . . (22)

Next, by iterating this result we find that

η=K₁⁺Φ−K₁⁺K₂K₁⁺ [symbol] K₁⁺Φ [symbol] η+. . . , (23)

which is a functional expansion for η in tensor powers of Φ. We will refer to (23) as the inverse scattering series for diffusion tomography.

Several comments on the above result are necessary. First,

(23) provides a formally exact solution to the inverse problem in diffusion tomography. It may be viewed as a nonlinear inversion formula whose first term coincides with the pseudoinverse solution to the linearized ISP. The higher order terms represent systematically improvable nonlinear corrections which, in principle, can be computed to arbitrarily high order. Thus, it is only necessary to solve the linear ISP in order to formally solve the nonlinear ISP. Second, (23) may also be obtained by formal inversion of the functional power series (9). This results in an explicit formula for the coefficient [symbol] ₙ of the nth term in (23):

$${𝒦}_{n} = - ( {\sum }_{p = 1}^{n - 1} {𝒦}_{p} {\sum }_{{i}_{1} + ⋯ + {i}_{p} = n}^{} {K}_{{i}_{1}} ⊗ ⋯ ⊗ {K}_{{i}_{p}} ) {𝒦}_{1} ⊗ ⋯ ⊗ {𝒦}_{1} , \qquad ( 24 )$$

where [symbol] ₁, =K₁⁺. See Section 6.1 Third, it may be seen that the coefficients of all the higher order terms in (23) have K₁⁺ as a prefactor. As a result, to any finite order, the spatial resolution of images reconstructed using the nonlinear theory can never exceed the resolution of images reconstructed by linear means alone. Fourth, the short-range propagation of diffusive waves implies that the forward scattering problem in diffusion tomography is weakly nonlinear. This is precisely the condition under which the inverse scattering series may be expected to exhibit fast convergence. Finally, the approach to the ISP based on (23) differs from Newton-type methods. This follows from the fact that such methods require the forward problem to be solved for each iteration.

3. Nonlinear Inversion in the Plane Geometry

The inverse scattering series was developed in a form which is independent of geometry. We now specialize to the case of the planar geometry. Other cases including the cylindrical and spherical geometries may also be considered.

3.1 Inversion Formulas

In the planar geometry measurements are taken on two parallel planes. Sources are taken to be located on the z=0 plane and detectors on the plane z=L. The object 105 to be imaged lies between the planes in the region 0<z<L. In this geometry, the unperturbed Green's function is given by the plane-wave decomposition

$${G}_{0} ( r , {r}^{′} ) = \int \frac{{d}^{2} q}{{( 2 π )}^{2}} g ( q ; z , {z}^{′} ) exp [ ⅈ q \cdot ( ρ - {ρ}^{′} ) ] , \qquad ( 25 )$$

where we have used the notation r=(ρ, z). In the case of free boundaries, the function g(q; z, z′) is given by

$$g ( q ; z , {z}^{′} ) = \frac{exp [ - Q ( q ) \vert z - {z}^{′} \vert ]}{2 Q ( q ) {D}_{0}} \qquad ( 26 )$$

and in the case of boundary conditions of the type expressed by equation (2)

$$g ( q ; z , {z}^{′} ) = \frac{l}{{D}_{0}} \frac{sinh [ Q ( q ) ( L - \vert z - {z}^{′} \vert ) ] + Q ( q ) l cosh [ Q ( q ) ( L - \vert z - {z}^{′} \vert ) ]}{sinh ( Q ( q ) L ) + 2 Q ( q ) l cosh ( Q ( q ) L ) + {( Q ( q ) l )}^{2} sinh ( Q ( q ) L )} , \qquad ( 27 )$$

where

Q(q)≡(q²+k²)^{1/2} (28)

and we have assumed that either r or r′ lies on one of the measurement planes.

We will find it advantageous to rewrite the inverse scattering series (23) in the form

η=η⁽¹⁾+η⁽²⁾+ (29)

η⁽¹⁾=K₁⁺Φ (30)

η₍₂₎=K₁⁺K₂η⁽¹⁾ [symbol] η⁽¹⁾, (31)

where η⁽¹⁾ is the solution to the linearized ISP and η⁽²⁾ is the first nonlinear correction. In the planar geometry, since the measurement planes have translational symmetry, it is natural to express (30) and (31) in the Fourier basis of two-dimensional plane waves. In this representation (30) and (31) become

η⁽¹⁾(r)=∫d²q₁d²q₂K₁⁺(r,q₁,q₂)Φ(q₁,q₂) (32)

η⁽²⁾(r)=∫d²q₁d²q₂∫d³r′d³r″K₁⁺(r;q₁,q₂)K₂(q₁,q₂;r′,r″)η⁽¹⁾(r′)η⁽¹⁾(r″) (33)

Here

Φ(q₁,q₂)=∫d²p₁d²p₂exp{i(q₁·p₁+q₂·p₂)}Φ(p₁,z₁,p₂,z₂), (34)

K(q₁,q₂)=∫d²q₁d²q₂exp{i(q₁·p₁+q₂·p₂)}K(p₁,z₁,p₂,z₂;·). (35)

Note that according to (32) and (33), once K₁⁺(r; q₁, q₂) is determined the inverse problem is solved, in principle.

3.2 Singular Value Decomposition of K₁⁺

The SVD of the pseudoinverse operator K₁⁺is given by

$${K}_{1}^{+} ( r ; {q}_{1} , {q}_{2} ) = \int \frac{1}{σ} {f}_{σ} ( r ) {g}_{σ}^{*} ( {q}_{1} , {q}_{2} ) ⅆ σ , \qquad ( 36 )$$

where σ is the singular value associated with the singular functions f_{σ}and g_{σ}. The singular functions are eigenfunctions with eigenvalues σ₂ of the positive self-adjoint operators K₁*K₁ and K₁K*₁:

K₁^{*}K₁f_{σ}=σ²f_{σ}, (37)

K₁K₁^{*}g_{σ}=σ²g_{σ}. (38)

In addition, the singular functions are related by

K₁f_{σ}=σg_{σ}, (39)

K₁^{*}g_{σ}=σf_{σ}. (40)

To proceed further, we require an explicit expression for K₁ (q₁, q₂; r). This is obtained by using the definitions of G₀ from Eq. (25) and K₁ from Eqs. (14,15) to carry out the Fourier transformation in Eq. (35):

K₁(q₁,q₂;r)=κ(q₁,q₂;z)exp{i(q₁+q₂)·p}, (41)

where the components of κ are given by

$$\begin{matrix}{κ}_{1} ( {q}_{1} , {q}_{2} ; z ) = β g ( {q}_{1} ; {z}_{1} , z ) g ( {q}_{2} ; z , {z}_{2} ) , \\ \begin{matrix}{κ}_{1} ( {q}_{1} , {q}_{2} ; z ) = β ( \frac{\partial g ( {q}_{1} ; {z}_{1} , z )}{\partial z} \frac{\partial g ( {q}_{2} ; z , {z}_{2} )}{\partial z} - \\ {q}_{1}^{′} \cdot {q}_{2} g ( {q}_{1} ; {z}_{1} , z ) g ( {q}_{2} ; z , {z}_{2} ) ) .\end{matrix}\end{matrix} \qquad ( 42 )$$

Using (41), we find that the matrix elements of the operator K₁,K*₁ are given by

$$\begin{matrix}{K}_{1} {K}_{1}^{*} ( {q}_{1} , {q}_{2} ; {q}_{1}^{′} , {q}_{2}^{′} ) = \int {ⅆ}^{2} Q δ ( Q - {q}_{1} - {q}_{2} ) δ ( Q - {q}_{1}^{′} - {q}_{2}^{′} ) \times \\ M ( \frac{1}{2} ( {q}_{1} - {q}_{2} ) , \frac{1}{2} ( {q}_{1}^{′} - {q}_{2}^{′} ) ; Q ) ,\end{matrix} \qquad ( 44 )$$

where

$$M ( P , {P}^{′} ; Q ) = {( 2 π )}^{2} {\int }_{0}^{L} ⅆ z k ( Q / 2 + P , Q / 2 - P ; z ) {k}^{*} ( Q / 2 + {P}^{′} , Q / 2 - {P}^{′} ; z ) . \qquad ( 45 )$$

To find the singular functions, we make the ansatz

g_{QQ′}(q₁, q₂)∫d²PC_{Q′}(P; Q)δ(q₁−Q/2−P)δ(q₂−Q/2+P), (46)

where Q and Q′ are two-dimensional wavevectors. Eq. (38) now implies that

∫d²P′M(P, P′; Q)C_{Q′}(P′; Q)=σ_{QQ′}C_{Q′}(P; Q), (47)

that is C_{Q′}(P; Q) is an eigenfunction of M(P, P′; Q) labeled by Q′ with eigenvalue σ_{QQ′}². Note that since M(Q) is self-adjoint, the C_{Q′}(P; Q) may be taken to be orthonormal. The singular functions f_{QQ′} may be found from (40) by direct calculation:

$${f}_{{QQ}^{′}} ( r ) = \frac{1}{{σ}_{{QQ}^{′}}} \int {ⅆ}^{2} P exp ( - ⅈ Q \cdot ρ ) {κ}^{*} ( Q / 2 + P , Q / 2 - P ; z ) {C}_{{Q}^{′}} ( P ; Q ) . \qquad ( 48 )$$

It follows that the SVD of K₁⁺is given by the expression

$${K}_{1}^{+} ( r ; {q}_{1} , {q}_{2} ) = \int {ⅆ}^{2} Q {ⅆ}^{2} {Q}^{′} \frac{1}{{σ}_{{QQ}^{′}}} {f}_{{QQ}^{′}} ( r ) {g}_{{QQ}^{′}}^{*} ( {q}_{1} , {q}_{2} ) . \qquad ( 49 )$$

The above expression for the SVD of K₁⁺may be simplified by using the spectral decomposition

$${M}^{- 1} ( P , {P}^{′} ; Q ) = \int {ⅆ}^{2} {Q}^{′} \frac{1}{{σ}_{{QQ}^{′}}^{2}} {C}_{{Q}^{′}} ( P ; Q ) {C}_{{Q}^{′}}^{*} ( {P}^{′} ; Q ) \qquad ( 50 )$$

and the explicit expressions for the singular functions. Eq. (49) thus becomes

K₁⁺(r;q₁,q₂)=∫d²Qd²P′exp(−iQ·p)M⁻¹(P,P′;Q)×κ^{*}(Q/2+P,Q/2−P;z)δ(q₁−Q/2−P)δ(q₂−Q/2+P). (51)

Using this result, along with (32), we obtain η⁽¹⁾(r), the solution to the linearized ISP:

η⁽¹⁾(r)=∫d²Qd²Pd²P′exp(−iQ·ρ)M⁻¹(P,P′;Q)×κ^{*}(Q/2+P,Q/2−P;z)Φ(Q/2+P,Q/2−P). (52)

Note that the above inversion formula is based on a direct calculation of the pseudoinverse solution rather than a construction of the SVD of the linearized forward scattering operator.

4. Numerical Results

We now illustrate the inversion formulas derived with numerical examples. We work in the planar geometry with free boundary conditions. In addition, we assume a priori that there are no inhomogeneities in the diffusion coefficient (δD=0). This allows the use of a single modulation frequency which we set to zero. In this case the linearized inversion formula (52) can be written in the form

δα⁽¹⁾(r)=∫d²Qd²Pd²P′exp(−iQ·ρ)M⁻¹(P,P′;Q)×κ₁^{*}(Q/2+P,Q/2−P;z)Φ(Q/2+P,Q/2−P), (53)

where

$$M ( P , {P}^{′} ; Q ) = {( 2 π )}^{2} {\int }_{0}^{L} ⅆ z {κ}_{1} ( Q / 2 + P , Q / 2 - P ; z ) {κ}_{1}^{*} ( Q / 2 + {P}^{′} , Q / 2 - {P}^{′} ; z ) . \qquad ( 54 )$$

In practice, this formula must be discretized. Namely, we chose the vectors Q to occupy a square lattice with unit step size Δq=k₁=L⁻¹ inside the circle |Q|≦40Δq. The vectors P, P′ were chosen on a one-dimensional lattice coinciding with the x-axis; the spacing was Δp=5Δq=5ΔL⁻¹, and 0≦|P|<40L⁻¹. Thus a total of eight different vectors P were used (including P=0). Note that for numerical calculation of M⁻¹, the operator M becomes a square matrix which can be diagonalized by the methods of linear algebra. In order to avoid numerical instability, the calculation of M⁻¹ must be regularized. In particular, we replace 1/σ by R(σ) where R is a suitable regularizer. The effect of regularization is to limit the contribution of small singular values to the reconstruction. The simplest way to do this is to simply cutoff all σ below some cutoff σ_{c}. That is, we set

$$R ( σ ) = \frac{1}{σ} θ ( σ - {σ}_{c} ) , \qquad ( 55 )$$

θdenoting the usual Heavyside step function.

The forward data were calculated for a spherical absorbing inhomogeneity. The data function Φ(q₁, q₂) is given in the Section 6.2. The diffuse wave numbers are given by k₁²=α₀/D₀ outside the sphere and k₂²=(α₀+a)/D₀ inside the sphere. Thus, inside the sphere we have δα=a=D₀(k₂²−k₁²) and we have chosen D₀=1, k₁=L⁻¹. Reconstructions were carried out in the volume −L≦x, y≦L, 0<z<L with the center of absorbing sphere placed at the point (0, 0, L/2). The sphere's radius was taken to be R=0.4L and the corresponding size parameter of the sphere was k₁R=0.4.

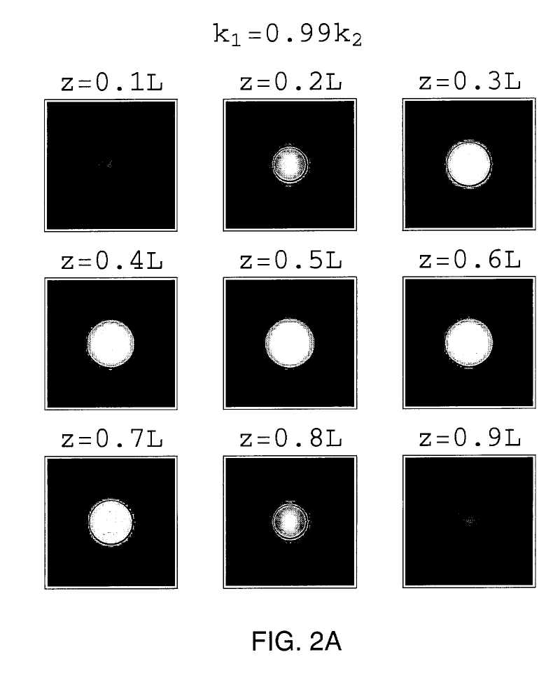

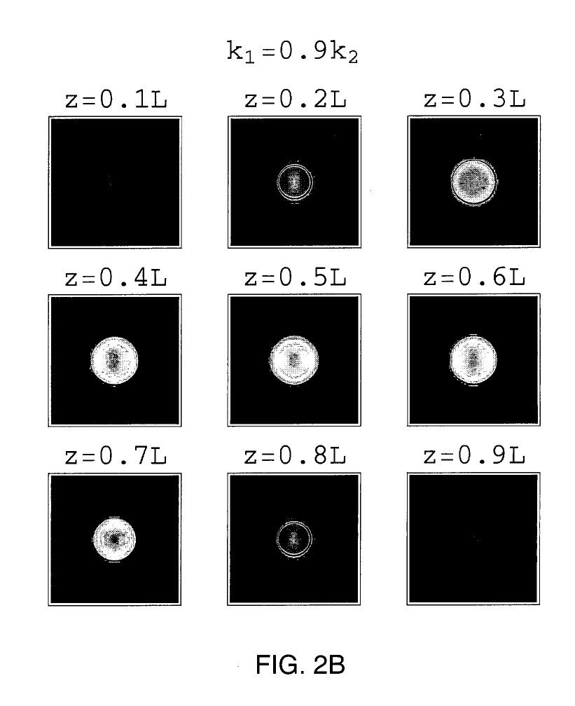

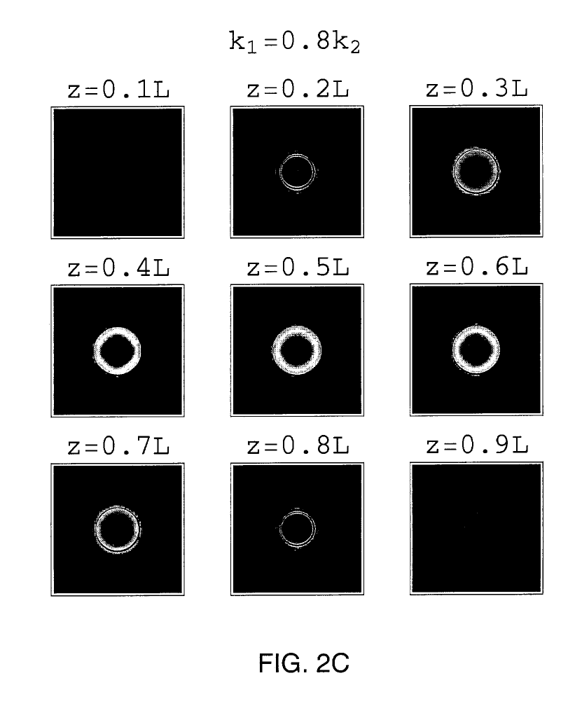

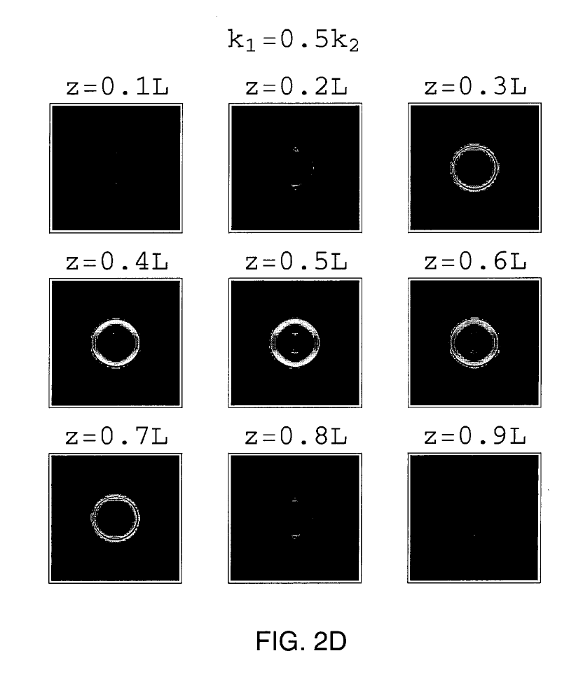

The results of linear reconstruction (δα⁽¹⁾) are shown in FIGS. 2A-2D for k₁=0.99k₂, k₁=0.8k₂, k₁=0.8k₂, and k₁=0.5k₂, respectively. Generally, tomographic slices are drawn at different depths z for an absorbing sphere with different values of k₂. The solid black circles indicate the physical boundary of the absorbing sphere. The reconstructed images are normalized by the “true” value of δα, D₀(k₂²−k₁²). A linear gray scale is employed; white corresponds to 1 and black to 0. In the case k₁=0.99k₂ (FIG. 2A), the weak scattering approximation is quite accurate. As a result, the quality of reconstructed images is high even to lowest order in δα. As the mismatch of the absorption inside and outside the sphere becomes larger, the quality of the linearized inversion decreases. In particular, a false dark area in the center of the sphere develops. In the case k₁=0.5k₂ (δα/α₀=3) shown in FIG. 2D, only a thin outer shell is reconstructed, while the inside area of the sphere is almost completely black. This is explained by the fact that in the weak scattering approximation the inhomogeneities are probed by the unperturbed incident field. However, the field inside more absorbing areas, such as the absorbing sphere in this numerical example, differs from the incident field. In essence, the field does not penetrate into areas with very high absorption. The linearized reconstruction “interprets” this fact as the absence of inhomogeneity. Note that although linearized inversion is not accurate when δα/α₀>1, it still reconstructs the correct shape of an inhomogeneity. Thus, although the internal region of the absorbing sphere in the case k₁=0.5k₂ is not reconstructed, the overall spherical shape is reconstructed correctly. It is expected that this is a general property of the linearized reconstruction and is not limited to spherical shapes.

We now consider the first nonlinear correction δα⁽²⁾ which is given by

δα⁽²⁾(r)=∫d²Qd²Pd²P′exp(−i−Q·ρ)M⁻¹(P,P′;Q)×κ*₁(Q/2+P,Q/2−P;z)Φ⁽¹⁾(Q/2+P,Q/2−P), (56)

where

Φ⁽¹⁾(q₁,q₂)=∫d³rd³r′K₂¹¹(q₁,q₂;r,r′)δα⁽¹⁾(r)δα⁽¹⁾(r′). (57)

Here K₂¹¹(q₁, q₂; r₁, r₂) is obtained by Fourier transformation of (16):

$$\begin{matrix}{K}_{2}^{11} ( {q}_{1} , {q}_{2} ; r , {r}^{′} ) = \frac{{G}_{0} ( r , {r}^{′} )}{{( 2 π {D}_{0} )}^{2} Q ( {q}_{1} ) Q ( {q}_{2} )} exp [ ⅈ ( {q}_{1} \cdot {ρ}_{1} + {q}_{2} \cdot {ρ}_{2} ) ] \times \\ exp [ - Q ( {q}_{1} ) \vert z - {z}_{1} \vert - Q ( {q}_{2} ) \vert z - {z}_{2} \vert ] .\end{matrix} \qquad ( 58 )$$

The quantity Φ⁽¹⁾(q₁, q₂) is calculated by numerical integration using the precomputed function δα⁽¹⁾.

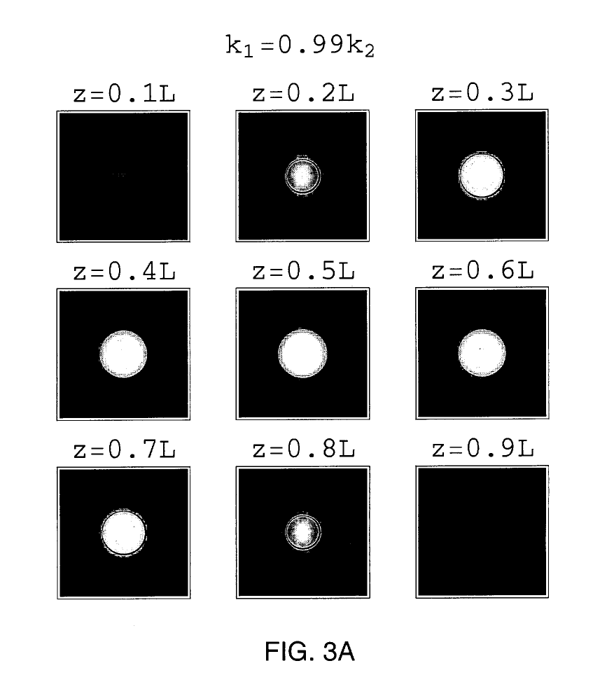

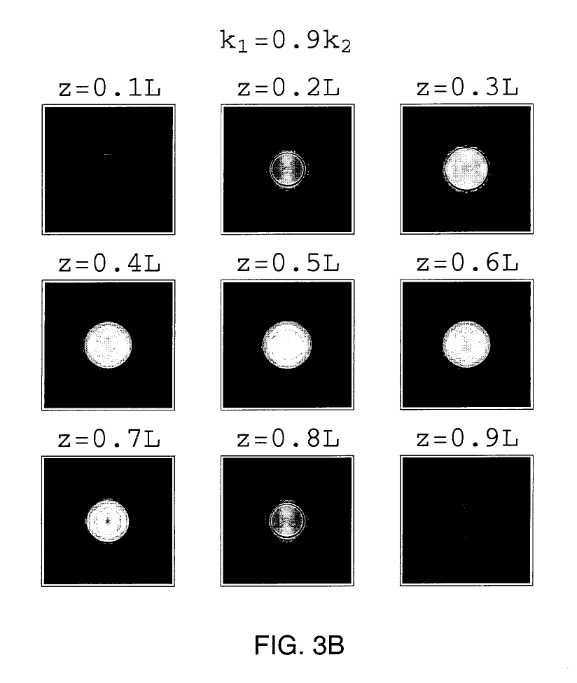

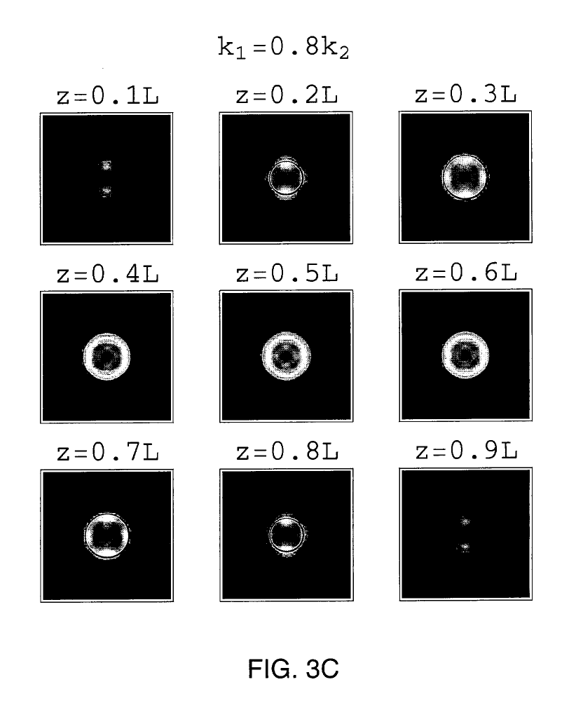

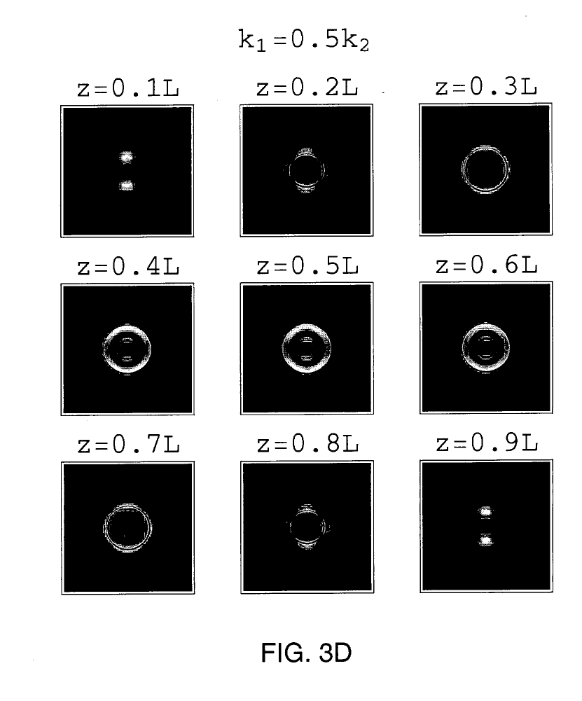

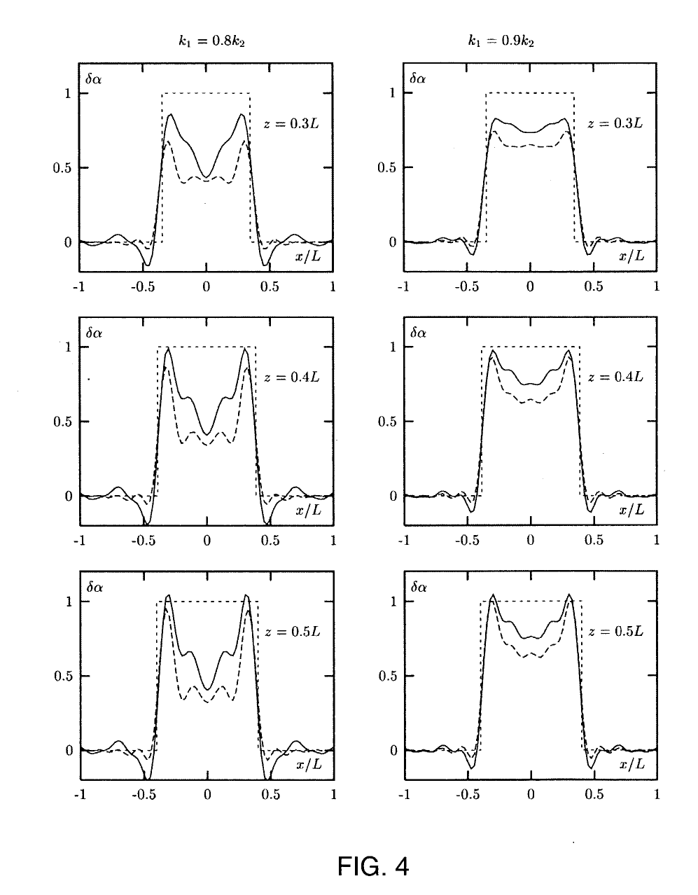

The reconstructed absorption coefficient with the first nonlinear correction (δα=δα⁽¹⁾+δα⁽²⁾) is shown in FIGS. 3A-3D for the same k₁ values of FIGS. 2A-2D As can be seen by comparing the panels with k₁=0.8k₂ and k₁=0.9k₂ in FIGS. 2B and 2C and FIGS. 3B and 3C, the effect of the first nonlinear correction is to fill in the voids that are seen in the linearized reconstruction. To illustrate this point more quantitatively, we plotted the reconstructed function δα, with and without the first non-linear correction, as a function of the x-coordinate on the one-dimensional line determined by z=const, y=0. The results are shown in FIG. 4. In particular, in this figure, the reconstructed function δα(r) is calculated along the line z=const (as indicated by the following legend for z) y=0, x ∈[−L, L]: (a) Long dash: δα=δα⁽¹⁾ (linearized inversion); (b) solid line: δα=δα⁽¹⁾+δα⁽²⁾ (first nonlinear correction); and (c) short dash: the true profile of δα. The effect of filling in the void in the center of the sphere is especially well manifested in the case k₁=0.9k₂.

As expected, the first nonlinear correction had no significant effect in the cases k₁=0.99k₂ and k₁=0.5k₂ (FIGS. 3A and 3C, respectively). In the first case, the linearized inversion already provides accurate results and all higher-order corrections are small. In the second case, the weak scattering approximation is strongly violated for the forward problem, and very high order corrections must be included to obtain convergence (provided the series converges at all).

5. Flow Diagrams

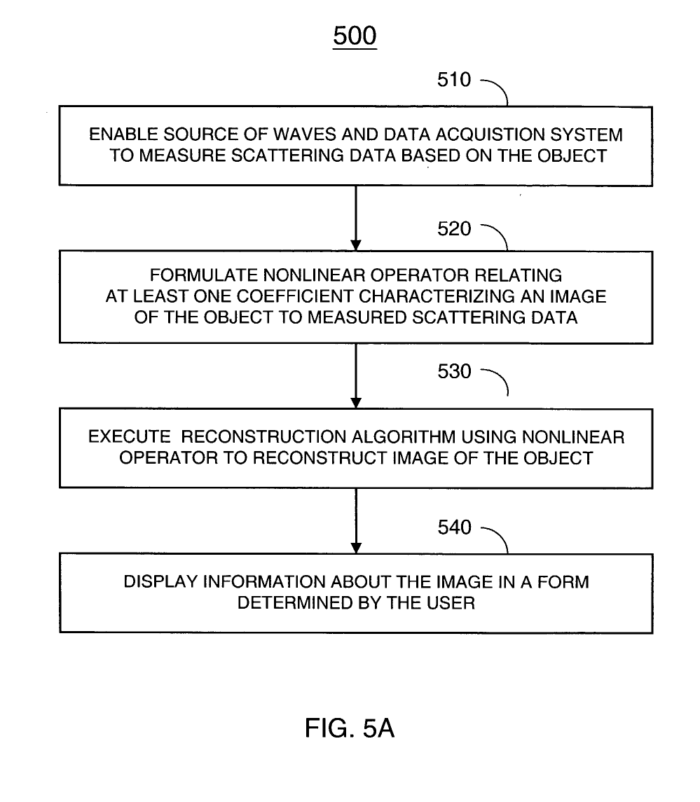

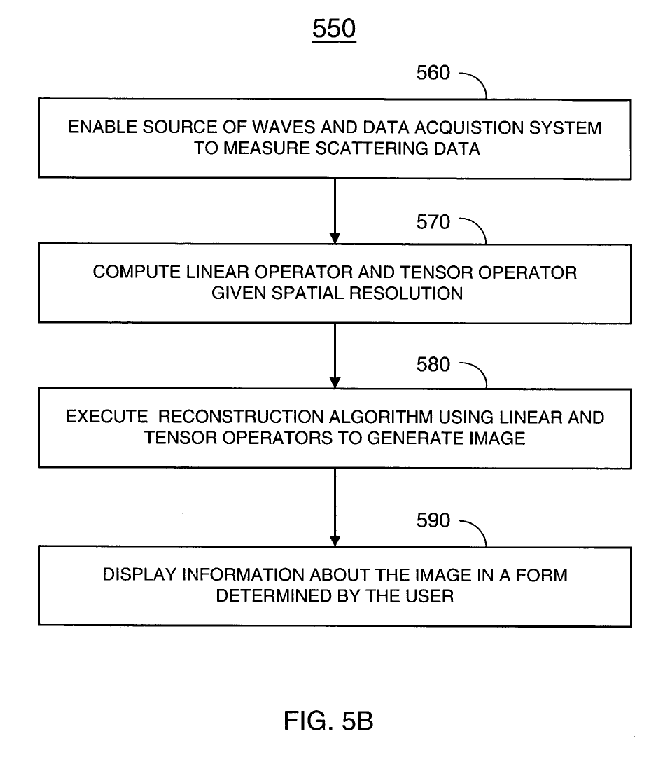

An embodiment illustrative of the methodology carried out by the subject matter of the present invention is set forth in high-level flow diagram 500 of FIG. 5A in terms of the illustrative system embodiment shown in FIG. 1. With reference to FIG. 5A, the processing effected by block 510 enables source 120 and data acquisition detector 130 so as to measure the scattering data emanating from scatterer 105 due to illumination from source 120. These measurements are passed to computer processor 150 from data acquisition detector 130 via bus 131. Next, processing block 520 is invoked to formulate the nonlinear operator relating at least one coefficient characterizing an image of the scatterer/object to the measured scattering data (e.g., equation (9)). In turn, processing block 530 is operated to execute the nonlinear reconstruction algorithm using the nonlinear operator formulation. Finally, as depicted by processing block 540, the reconstructed tomographic image corresponding to a is provided to output device 170 in a form determined by the user; device 170 may be, for example, a display monitor or a more sophisticated three-dimensional display device.

Another embodiment illustrative of the methodology carried out by the subject matter of the present invention is set forth in high-level flow diagram 550 of FIG. 5B in terms of the illustrative system embodiment shown in FIG. 1. With reference to FIG. 5B, the processing effected by block 560 enables source 120 and data acquisition detector 130 so as to measure the scattering data emanating from scatterer 105 due to illumination from source 120. These measurements are passed to computer processor 150 from data acquisition detector 130 via bus 131. Next, processing block 570 is invoked to compute the linear and tensor operators, that is, the operators given by equations (14) and (15) for the linear operator and equations (16)-(19) for the tensor operator. In turn, processing block 580 is operated to execute the reconstruction algorithm set forth in equation (23), that is, the inverse scattering series, which is a functional expansion for η in tensor products of Φ, is computed. Finally, as depicted by processing block 590, the reconstructed tomographic image corresponding to η is provided to output device 170 in a form determined by the user; device 170 may be, for example, a display monitor or a more sophisticated three-dimensional display device.

6.1 Inversion of Series

In this Section we show that the inverse scattering series (23) may be obtained by formal inversion of the forward scattering series

Φ=K₁η+K₂η [symbol] η+K₃η [symbol] η [symbol] η [symbol] η+. . . . (59)

To proceed, we assume that η may be expressed as a functional expansion in Φ:

η= [symbol] ₁Φ+ [symbol] ₂Φ [symbol] Φ+ [symbol] ₃Φ [symbol] Φ [symbol] Φ+. . . , (60)

where [symbol] ₁ is a linear operator which maps the Hilbert space H₂ into the Hilbert space H₁ and [symbol] ₙ is a tensor operator which maps H₂ [symbol] . . . [symbol] H₂ (n copies) into H₁ for n≧2. To find the [symbol] 's we substitute the expression (59) for Φ into (60) and equate terms with the same tensor power of η. We thus obtain the relations

[symbol]

₁K₁=I (61)

[symbol]

₂K₁ [symbol] K₁+ [symbol] ₁K₂=0 (62)

[symbol]

₃K₁ [symbol] K₁ [symbol] K₁+ [symbol] ₂K₁ [symbol] K₂+ [symbol] ₂K₂ [symbol] K₁+ [symbol] ₁K₃=0 (63)

$${\sum }_{p = 1}^{n - 1} {p}_{} {\sum }_{{i}_{1} + ⋯ + {i}_{p} = n} {K}_{{i}_{1}} ⊗ ⋯ ⊗ {K}_{{i}_{p}} + {n}_{} {K}_{1} ⊗ ⋯ ⊗ {K}_{1} = 0 , \qquad ( 64 )$$

which may be solved for the [symbol] 's with the result

[symbol]

₁=K₁⁺ (65)

[symbol]

₂=− [symbol] ₁K₂ [symbol] ₁ [symbol] [symbol] ₁ (66)

[symbol]

₃=−( [symbol] ₂K₁ [symbol] K₂+ [symbol] ₂K₂ [symbol] K₁+ [symbol] ₁K₃) [symbol] ₁ [symbol] [symbol] ₁ [symbol] ₁ (67)

$${n}_{} = - ( {\sum }_{p = 1}^{n - 1} {p}_{} {\sum }_{{i}_{1} + ⋯ + {i}_{p} = n} {K}_{{i}_{1}} ⊗ ⋯ ⊗ {K}_{{i}_{p}} ) {1}_{} ⊗ ⋯ ⊗ {1}_{} . \qquad ( 68 )$$

It can be seen that the above expressions for [symbol] ₁ and [symbol] ₂ agree with (23). In addition, (68) provides a general formula for the coefficients of the higher order terms in (23). We note this formula implies that the nonlinear correction of order n involves all forward operators up to order n.

6.2 The Data Function for a Spherical Inhomogeneity

In this Section we calculate the data function for an absorbing spherical inhomogeneity in an infinite medium. Note that the scattering of diffusing waves from a sphere is analogous to Mie scattering in electromagnetic theory.

Consider a spherical inclusion whose properties differ from the surrounding homogeneous background. We assume that δD=0 and δα=α=const inside a spherical region |r−r₀|<R. We will work in a reference frame whose origin coincides with the center of the sphere, ro. In this case, the Green's function can be represented as

$$G ( r , {r}^{′} ) = {\sum }_{l = 0}^{∞} {\sum }_{m = - l}^{l} {g}_{l} ( r , {r}^{′} ) {Y}_{l m}^{*} ( {\hat{r}}^{′} ) {Y}_{l m} ( \hat{r} ) , \qquad ( 69 )$$

where the Yₗₘ's are spherical harmonics. If both the sources and detectors are located outside the sphere (r, r′>R) then

$${g}_{l} ( r , {r}^{′} ) = \frac{2 {k}_{1}}{π {D}_{0}} [ {i}_{l} ( {k}_{1} {r}_{<} ) {k}_{l} ( {k}_{1} {r}_{>} ) - {F}_{l} {k}_{l} ( {k}_{1} r ) {k}_{l} ( {k}_{1} {r}^{′} ) ] , \qquad ( 70 )$$

where kₗ (x) and iₗ(x) are the modified spherical Bessel and Hankel functions of the first kind, r_{<} and r_{>} are the lesser and greater of r and r′, the Mie coefficient Fₗ is given by

$${F}_{l} = \frac{{k}_{2} {i}_{l} ( {k}_{1} R ) {i}_{l}^{′} ( {k}_{2} R ) - {k}_{1} {i}_{l} ( {k}_{2} R ) {i}_{l}^{′} ( {k}_{1} R )}{{k}_{2} {i}_{l}^{′} ( {k}_{2} R ) {k}_{l}^{′} ( {k}_{1} R ) - {k}_{1} {i}_{l} ( {k}_{2} R ) {k}_{l}^{′} ( {k}_{1} R )} , \qquad ( 71 )$$

and k₁ and k₂ are the wavenumbers outside and inside the sphere:

$$\begin{matrix}{k}_{1}^{2} = \frac{{α}_{0} - ⅈ ω}{{D}_{0}} , & {k}_{2}^{2} = \frac{{α}_{0} + a - ⅈ ω}{{D}_{0}} .\end{matrix} \qquad ( 72 )$$

By observing that in an infinite medium the unperturbed Green's function G₀(r, r′) can be written as

$${G}_{0} ( r , {r}^{′} ) = \frac{2 {k}_{1}}{π {D}_{0}} {\sum }_{l = 0}^{∞} {\sum }_{m = - l}^{l} {i}_{l} ( {k}_{1} {r}_{<} ) {k}_{l} ( {k}_{1} {r}_{>} ) {Y}_{l m}^{*} ( {\hat{r}}^{′} ) {Y}_{l m} ( \hat{r} ) , \qquad ( 73 )$$

we see that the first term in (70) can be identified as the incident field, while the second term represents the scattered field. Consequently, the data function θ(r₁, r₂) is given by

$$φ ( {r}_{1} , {r}_{2} ) = \frac{2 {k}_{1}}{π {D}_{0}} {\sum }_{l = 0}^{∞} {\sum }_{m = - l}^{l} {F}_{l} {k}_{l} ( {k}_{1} {r}_{1} ) {k}_{l} ( {k}_{1} {r}_{2} ) {Y}_{l m}^{*} ( {\hat{r}}_{2} ) {Y}_{l m} ( {\hat{r}}_{1} ) . \qquad ( 74 )$$

The above expression is valid in a reference frame whose origin is at the center of the sphere. The corresponding expression in an arbitrary reference frame is obtained by making the transformation r_{1,2} →r_{1,2}−r₀.

We now calculate the Fourier transformed data function Φ(q₁, q₂) which is defined by

Φ(q₁,q₂)=∫d²ρ₁d²ρ₂exp[i(q₁·ρ₁+q₂·ρ₂)]Φ(ρ₁,z₁,ρ₂,z₂). (75)

We will show that

$$φ ( {q}_{1} , {q}_{2} ) = \frac{{π}^{2}}{2 {D}_{0} {k}_{1} Q ( {q}_{1} ) Q ( {q}_{2} )} exp [ i ( {q}_{2} - {q}_{1} ) \cdot {ρ}_{c} - Q ( {q}_{1} ) \vert {z}_{0} - {z}_{1} \vert - Q ( {q}_{2} ) \vert {z}_{2} - {z}_{0} \vert ] \times {\sum }_{l = 0}^{∞} ( 2 l + 1 ) {F}_{l} {P}_{l} ( \frac{{q}_{1} \cdot {q}_{2} + γ ( {z}_{1} , {z}_{2} ) Q ( {q}_{1} ) Q ( {q}_{2} )}{{k}_{1}^{2}} ) , \qquad ( 76 )$$

where Pₗ(x) are the Legendre polynomials and

$$γ ( {z}_{1} , {z}_{2} ) = \{ \begin{matrix}1 , & if {z}_{1} = {z}_{2} \\ - 1 , & if {z}_{1} \neq {z}_{2} .\end{matrix} \qquad ( 77 )$$

Note that the arguments of the Legendre polynomials in (76) can be greater than unity; however the Mie coefficients Fₗ decay with l faster than exponentially so that the convergence of the series is guaranteed. To derive (76) we start by expanding Φ(r₁, r₂) in a three-dimensional Fourier integral. To this end we define Iₗₘ¹(p₁) and Iₗₘ² (p₂₎ such that

$$\begin{matrix}{k}_{l} ( {k}_{1} {r}_{1} ) {Y}_{lm} ( {\hat{r}}_{1} ) = \int \frac{{d}^{3} {p}_{1}}{{( 2 π )}^{3}} {I}_{lm}^{1} ( {p}_{1} ) exp ( - {ip}_{1} \cdot {r}_{1} ) , & ( 78 ) \\ {k}_{l} ( {k}_{1} {r}_{2} ) {Y}_{lm}^{*} ( {\hat{r}}_{2} ) = \int \frac{{d}^{3} {p}_{2}}{{( 2 π )}^{3}} {I}_{lm}^{2} ( {p}_{2} ) exp ( - {ip}_{2} \cdot {r}_{2} ) , & ( 79 )\end{matrix}$$

Iₗₘ¹(p₁)=∫kₗ(k₁r)Yₗₘ(\hat{r})exp(ip₁·r)d³r, (80)

Iₗₘ²(p₂)=∫kₗ(k₁r)Yₗₘ^{*}(\hat{r})exp(ip₂·r)d³r. (81)

The integrals (80) and (81) are evaluated by using the identity

$$exp ( ip \cdot r ) = 4 π {\sum }_{l = 0}^{∞} {\sum }_{m = - l}^{l} {i}^{l} {j}_{l} ( pr ) {Y}_{lm}^{*} ( \hat{p} ) {Y}_{lm} ( \hat{r} ) , \qquad ( 82 )$$

where jₗ(x) are spherical Bessel functions of the first kind. After expanding the exponents in (80) and (81) according to (82) and integrating over the angular variables we obtain

$$\begin{matrix}{I}_{lm}^{1} ( {p}_{1} ) = 4 π {i}^{l} {Y}_{lm} ( {\hat{p}}_{1} ) {\int }_{0}^{∞} {r}^{2} {k}_{l} ( {k}_{1} r ) {j}_{l} ( {p}_{1} r ) ⅆ r , & ( 83 ) \\ {I}_{lm}^{2} ( {p}_{2} ) = 4 π {i}^{l} {Y}_{lm}^{*} ( {\hat{p}}_{2} ) {\int }_{0}^{∞} {r}^{2} {k}_{l} ( {k}_{1} r ) {j}_{l} ( {p}_{2} r ) ⅆ r . & ( 84 )\end{matrix}$$

The one-dimensional integrals are easily calculated using the formula

$${\int }_{0}^{∞} {x}^{2} {k}_{l} ( ax ) {j}_{l} ( {b}_{x} ) ⅆ x = \frac{π}{2 a} \frac{{( b / a )}^{l}}{{a}^{2} + {b}^{2}} . \qquad ( 85 )$$

Combining the above results, we can write the three-dimensional Fourier expansion of Φ(r₁, r₂):

$$φ ( {r}_{1} , {r}_{2} ) = \frac{1}{{( 2 π )}^{3} {D}_{0} {k}_{1}} {\sum }_{lm}^{} {( - 1 )}^{l} {F}_{l} \int {d}^{3} {p}_{1} {d}^{3} {p}_{2} \frac{{( {p}_{1} {p}_{2} / {k}_{1}^{2} )}^{l}}{( {p}_{1}^{2} + {k}_{1}^{2} ) ( {p}_{2}^{2} + {k}_{1}^{2} )} \times {Y}_{lm} ( {\hat{p}}_{1} ) {Y}_{lm}^{*} ( {\hat{p}}_{2} ) exp [ - i ( {p}_{1} \cdot ( {r}_{1} - {r}_{0} ) + {p}_{2} \cdot ( {r}_{2} - {r}_{0} ) ) ] . \qquad ( 86 )$$

where we have made the shift r_{1,2}→r_{1,2}−r₀. Thus the expression (86) is valid in an arbitrary reference frame

Next we decompose the three-dimensional vectors as P₁=−q₁+t₁ê_{z}, P₂=q₂+t₂ê_{z} and r₀=ρ₀+z₀ê_{z}. Taking into account that p_{1,2}²=q_{1,2}²+_{1,2}², this immediately leads to the following expression for the two-dimensional Fourier transform of Φ(r₁, r₂):

$$φ ( {q}_{1} , {q}_{2} ) = \frac{2 πexp [ i ( {q}_{1} + {q}_{2} ) \cdot {ρ}_{0} ]}{{D}_{0} {k}_{1}} {\sum }_{lm}^{} {( - 1 )}^{l} {F}_{l} {J}_{lm}^{1} ( {q}_{1} ) {J}_{lm}^{2} ( {q}_{2} ) , \qquad ( 87 )$$

where

$$\begin{matrix}{J}_{lm}^{1} ( {q}_{1} ) = {\int }_{- ∞}^{∞} ⅆ t \frac{{( \sqrt{{q}_{1}^{2} + {t}^{2}} / {k}_{1} )}^{l}}{{q}_{1}^{2} + {t}^{2} + {k}_{1}^{2}} {Y}_{lm} ( \frac{- {q}_{1} + t {\hat{e}}_{z}}{\sqrt{{q}_{1}^{2} + {t}^{2}}} ) exp [ it ( {z}_{0} - {z}_{1} ) ] & ( 88 ) \\ {J}_{lm}^{2} ( {q}_{2} ) = {\int }_{- ∞}^{∞} ⅆ t \frac{{( \sqrt{{q}_{2}^{2} + {t}^{2}} / {k}_{1} )}^{l}}{{q}_{2}^{2} + {t}^{2} + {k}_{1}^{2}} {Y}_{lm}^{*} ( \frac{{q}_{2} + t {\hat{e}}_{z}}{\sqrt{{q}_{2}^{2} + {t}^{2}}} ) exp [ it ( {z}_{0} - {z}_{1} ) ] . & ( 89 )\end{matrix}$$

Although the integrands in (88) and (89) contain square roots, they are analytic functions of t. This can be seen by examining the explicit expressions for the spherical harmonics in terms of the associated Legendre polynomials and observing that the square roots in question are raised to an even power for any l and m. Therefore, (88) and (89) can be evaluated by analytic continuation of the integrands into the complex plane and contour integration. The result is

$$\begin{matrix}{J}_{lm}^{1} ( {q}_{1} ) = \frac{π {i}^{l}}{Q ( {q}_{1} )} {Y}_{lm} ( \frac{- {q}_{1} + i sgn ( {z}_{0} - {z}_{1} ) Q ( {q}_{1} ) {\hat{e}}_{z}}{{ik}_{1}} ) exp [ - Q ( {q}_{1} ) \vert {z}_{0} - {z}_{1} \vert ] , & ( 90 ) \\ {J}_{lm}^{2} ( {q}_{2} ) = \frac{π {i}^{l}}{Q ( {q}_{1} )} {Y}_{lm}^{*} ( \frac{{q}_{2} + i sg n ( {z}_{0} - {z}_{2} ) Q ( {q}_{2} ) {\hat{e}}_{z}}{{ik}_{1}} ) exp [ - Q ( {q}_{2} ) \vert {z}_{0} - {z}_{2} \vert ] . & ( 91 )\end{matrix}$$

Note that the spherical harmonic functions in the above expressions are analytically continued to complex angles; the arguments of Yₗₘ in (90) and (91) are complex unit vectors with the property a·a=1.

Finally, we use the addition theorem to perform the summation over the index m in (87):

$${\sum }_{m = - 1}^{l} {Y}_{lm} ( \frac{- {q}_{1} + i sgn ( {z}_{0} - {z}_{1} ) Q ( {q}_{1} ) {\hat{e}}_{z}}{{ik}_{1}} ) {Y}_{lm}^{*} ( \frac{{q}_{2} + i sg n ( {z}_{0} - {z}_{2} ) Q ( {q}_{2} ) {\hat{e}}_{z}}{{ik}_{1}} ) = \frac{2 l + 1}{4 π} {P}_{l} ( cos θ ) , \qquad ( 92 )$$

where θ is the angle between the two complex vector arguments of the spherical harmonic functions in (92). The cosine of this angle is obviously given by

$$cos θ = \frac{{q}_{1} \cdot {q}_{2} + sgn ( {z}_{0} - {z}_{1} ) sgn ( {z}_{0} - {z}_{2} ) Q ( {q}_{1} ) Q ( {q}_{2} )}{{k}_{1}^{2}} . \qquad ( 93 )$$

Taking into account that sgn(z₀−z₁)sgn(z₀−Z₂)=γ(z₁, Z₂), we obtain the result (76).

Although the present invention has been shown and described in detail herein, those skilled in the art can readily devise many other varied embodiments that still incorporate these teachings. Thus, the previous description merely illustrates the principles of the invention. It will thus be appreciated that those with ordinary skill in the art will be able to devise various arrangements which, although not explicitly described or shown herein, embody principles of the invention and are included within its spirit and scope. Furthermore, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently know equivalents as well as equivalents developed in the future, that is, any elements developed that perform the function, regardless of structure.

In addition, it will be appreciated by those with ordinary skill in the art that the block diagrams herein represent conceptual views of illustrative circuitry embodying the principles of the invention.

What is claimed is:

1. A method for generating an image of an object comprising
irradiating the object with a source of radiation,
measuring a transmitted intensity due to diffusively scattered radiation wherein said transmitted intensity is related to at least one coefficient characterizing the image by a nonlinear integral operator, and
directly reconstructing the image by executing a prescribed mathematical algorithm, determined with reference to said nonlinear integral operator, on said transmitted intensity.

2. The method as recited in claim 1 wherein said at least one coefficient is a diffusion coefficient.

3. The method as recited in claim 1 wherein said at least one coefficient is an absorption coefficient.

4. The method as recited in claim 1 wherein said at least one coefficient includes both an absorption coefficient and a diffusion coefficient.

5. A system for generating an image of an object comprising
radiation source means for irradiating the object,
detector means for measuring a transmitted intensity due to diffusively scattered radiation wherein said transmitted intensity is related to at least one coefficient characterizing the image by a nonlinear integral operator, and
means for directly reconstructing the image by executing a prescribed mathematical algorithm, determined with reference to said nonlinear integral operator, on said transmitted intensity.

6. The system as recited in claim 5 wherein said at least one coefficient is a diffusion coefficient.

7. The system as recited in claim 5 wherein said at least one coefficient is an absorption coefficient.

8. The system as recited in claim 5 wherein said at least one coefficient includes both an absorption coefficient and a diffusion coefficient.

9. A method for generating an image of an object comprising
irradiating the object with a source of radiation,
measuring a transmitted intensity due to diffusively scattered radiation wherein said transmitted intensity is related to a coefficient characterizing the image by a nonlinear integral operator, and
directly reconstructing the image by executing a prescribed mathematical algorithm, determined with reference to said nonlinear integral operator, on said transmitted intensity, said algorithm further relating said at least one coefficient to said transmitted intensity by another nonlinear integral operator.

10. The method as recited in claim 9 wherein said at least one coefficient is a diffusion coefficient.

11. The method as recited in claim 9 wherein said at least one coefficient is an absorption coefficient.

12. The method as recited in claim 9 wherein said at least one coefficient includes both an absorption coefficient and a diffusion coefficient.

13. A system for generating an image of an object comprising
irradiation means for irradiating the object with a source of radiation,
measurement means, responsive to the means for irradiating, for measuring a transmitted intensity due to diffusively scattered radiation wherein said transmitted intensity is related to a coefficient characterizing the image by a nonlinear integral operator, and
reconstruction means, responsive to the means for measuring, for directly reconstructing the image by executing a prescribed mathematical algorithm, determined with reference to said nonlinear integral operator, on said transmitted intensity, said algorithm further relating said at least one coefficient to said transmitted coefficient by another nonlinear integral operator.

14. The system as recited in claim 13 wherein said at least one coefficient is a diffusion coefficient.

15. The system as recited in claim 13 wherein said at least one coefficient is an absorption coefficient.

16. The system as recited in claim 13 wherein said at least one coefficient includes both an absorption coefficient and a diffusion coefficient.

17. A method for generating a tomographic image of an object comprising
irradiating the object with a source of radiation,
measuring a transmitted intensity due predominantly to diffusively scattered radiation wherein the transmitted intensity is related a coefficient characterizing the image by an integral operator, and
directly reconstructing the image by executing a prescribed mathematical algorithm, determined with reference to the integral operator, on the transmitted intensity, the mathematical algorithm expressed as a functional series expansion for the coefficient in powers of the transmitted intensity.

18. The method as recited in claim 17 wherein said at least one coefficient is a diffusion coefficient.

19. The method as recited in claim 17 wherein said at least one coefficient is an absorption coefficient.

20. The method as recited in claim 17 wherein said at least one coefficient includes both an absorption coefficient and a diffusion coefficient.

21. A system for generating an image of an object comprising
radiation source means for irradiating the object,
detector means for measuring a transmitted intensity due to diffusively scattered radiation wherein said transmitted intensity is related to at least one coefficient characterizing the image by a nonlinear integral operator, and
means for directly reconstructing the image by executing a prescribed mathematical algorithm, determined with reference to said nonlinear integral operator, on said transmitted intensity, the mathematical algorithm expressed as a functional series expansion for the coefficient in powers of the transmitted intensity

22. The system as recited in claim 21 wherein said at least one coefficient is a diffusion coefficient.

23. The system as recited in claim 21 wherein said at least one coefficient is an absorption coefficient.

24. The system as recited in claim 21 wherein said at least one coefficient includes both an absorption coefficient and a diffusion coefficient.

25. A method for generating an image of an object comprising
irradiating the object with a source of radiation,
measuring a transmitted intensity due to diffusively scattered radiation wherein said transmitted intensity is related to the absorption coefficient and the diffusion coefficient by a nonlinear integral operator, and
directly reconstructing the image by executing a prescribed mathematical algorithm, determined with reference to said nonlinear integral operator, on said transmitted intensity.

26. The method as recited in claim 25 wherein the directly reconstructing includes computing a linear operator and a tensor operator.

27. The method as recited in claim 26 wherein the directly reconstructing includes computing the functional expansion using the linear operator and the tensor operator.

28. The method as recited in claim 25 wherein the integral operator is an integral equation, and the directly reconstructing includes using a linearized solution to the integral equation to determine higher order corrections to the linearized solution.

29. A method for generating a tomographic image of an object comprising
irradiating the object with a continuous wave source of radiation,
measuring a transmitted intensity due predominantly to diffusively scattered radiation wherein the transmitted intensity
computing a linear operator and a tensor operator from a Green's function for a homogenous medium containing the object, and
directly reconstructing the image by computing a functional series expansion for the absorption coefficient and the diffusion coefficient in terms of the linear operator and the tensor operator and powers of the transmitted intensity.
